(19) United States
(12) Patent Application Publication
(10) Pub. No.: US 2019/0146628 A1
(43) Pub. Date: May 16, 2019

(54) TOUCH PANEL DISPLAY DEVICE, TOUCH PANEL CONTROL METHOD, AND RECORDING MEDIUM STORING TOUCH PANEL CONTROL PROGRAM

(71) Applicant: SHARP KABUSHIKI KAISHA, Sakai City (JP)

(72) Inventors: AKIYOSHI OHYA, Sakai City (JP); AKIHISA KOBAYASHI, Sakai City (JP)

(21) Appl. No.: 16/186,331

(22) Filed: Nov. 9, 2018

(30) Foreign Application Priority Data
Nov. 10, 2017 (JP) 2017-217072

(51) Int. Cl. G06F 3/041

(52) U.S. Cl. CPC G06F 3/0416; G06F 3/044

(57) ABSTRACT

A touch panel display device includes a display unit, a touch panel, a display processing unit, a setting processing unit, and a restriction processing unit. The touch panel detects a touch operation on the display unit, the display processing unit displays a specific image on a part or all of a display screen of the display unit in a state where an input image is being displayed on the display unit, the setting processing unit sets an operation restriction range according to a touch operation on the specific image, and the restriction processing unit switches whether to perform output of operation information corresponding to the position of the touch operation to an external device according to whether the position of the touch operation detected by the touch panel is within the operation restriction range.

### BACKGROUND

### 1. Field

The present disclosure relates to a touch panel display device including a touch panel capable of detecting a touch operation on a display unit.

### 2. Description of the Related Art

In general, a touch panel display device that includes a touch panel capable of detecting a touch operation on a display unit and is capable of outputting operation information such as position coordinates of the touch operation to a computer or the like is known. A technology in which a dedicated setting screen for setting an operation invalid range on the touch panel can be displayed and the operation invalid range can be set according to a user's operation on the setting screen is known (see, for example, Japanese Unexamined Patent Application Publication No. 2005-276120).

However, in a configuration in which the dedicated setting screen is displayed when an operation invalid range that restricts validity of an operation on a touch panel is set, there is a problem that it is unable to set an operation restriction range while a positional relationship with an input image actually displayed on a display unit is confirmed. For that reason, for example, in a case where an input image corresponding to document data such as a contract or a meeting document is displayed on the display unit, it is difficult for a user to randomly set a specific area in the document data as an operation restriction range such as an operation invalid range or an operation valid range.

It is desirable to provide a touch panel display device, a touch panel control method, and a recording medium storing a touch panel control program that enable a user to easily set a desired operation restriction range while ascertaining a positional relationship with an input image displayed on a display unit.

### SUMMARY

According to an aspect of the disclosure, there is provided a touch panel display device which includes a display unit, a touch panel capable of detecting a position of a touch operation on the display unit, a display processing unit capable of displaying a specific image on a part or all of a display screen of the display unit in a state where an input image is being displayed on the display unit, a setting processing unit capable of setting an operation restriction range according to a touch operation on the specific image, and a restriction processing unit capable of switching whether to perform output of operation information corresponding to the position of the touch operation to an external device according to whether the position of the touch operation detected by the touch panel is within the operation restriction range.

According to another aspect of the disclosure, there is provided a touch panel control method executed in a touch panel display device including a display unit and a touch panel capable of detecting a position of a touch operation on the display unit and includes, displaying a specific image on a part or all of a display screen of the display unit in a state where an input image is being displayed on the display unit, setting an operation restriction range according to a touch operation on the specific image, and switching whether to perform output of operation information corresponding to the position of the touch operation to an external device according to whether the position of the touch operation detected by the touch panel is within the operation restriction range.

According to still another aspect of the disclosure, there is provided a non-transitory recording medium storing a program that causes a computer of a touch panel display device including a display unit and a touch panel capable of detecting a position of a touch operation on the display unit to execute a process, and the process includes displaying a specific image on a part or all of a display screen of the display unit in a state where an input image is being displayed on the display unit, setting an operation restriction range according to a touch operation on the specific image, and switching whether to perform output of operation information corresponding to the position of the touch operation to an external device according to whether the position of the touch operation detected by the touch panel is within the operation restriction range.

### BRIEF DESCRIPTION OF THE DRAWINGS

FIG. 1 is a block diagram illustrating a configuration of a touch panel display device according to an embodiment of the disclosure;

FIG. 2 is a flowchart illustrating an example of a procedure of operation restriction setting processing executed in the touch panel display device according to the embodiment of the disclosure;

FIG. 3 is a flowchart illustrating an example of a procedure of touch operation processing executed in the touch panel display device according to the embodiment of the disclosure;

FIG. 4 is a flowchart illustrating an example of a procedure of display change control processing executed by the touch panel display device according to the embodiment of the disclosure;

FIG. 5 is a diagram illustrating a display example in the touch panel display device according to the embodiment of the disclosure;

FIG. 6 is a diagram illustrating a display example in the touch panel display device according to the embodiment of the disclosure;

FIG. 7 is a diagram illustrating a display example in the touch panel display device according to the embodiment of the disclosure;

FIG. 8 is a diagram illustrating a display example in the touch panel display device according to the embodiment of the disclosure;

FIG. 9 is a diagram illustrating a display example in the touch panel display device according to the embodiment of the disclosure;

FIG. 10 is a diagram illustrating a display example in the touch panel display device according to the embodiment of the disclosure; and

FIG. 11 is a diagram illustrating a display example in the touch panel display device according to the embodiment of the disclosure.

### DESCRIPTION OF THE EMBODIMENTS

Hereinafter, an embodiment of the disclosure will be described with reference to the accompanying drawings to support an understanding of the disclosure. The following embodiment is an example of embodying the disclosure, and does not limit the technical scope of the disclosure.

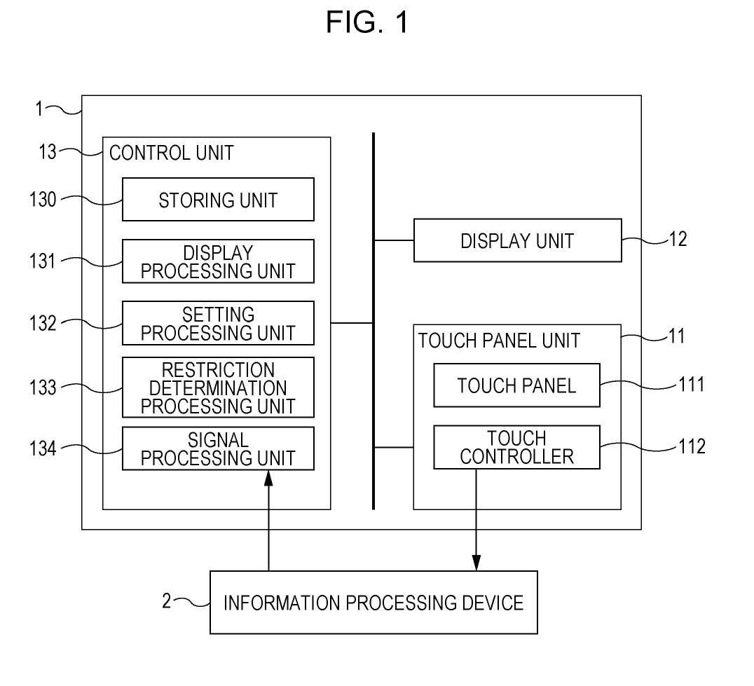

As illustrated in FIG. 1, a touch panel display device 1 includes a touch panel unit 11, a display unit 12, a control unit 13, and the like. The touch panel display device 1 is connected to an information processing device 2 such as a personal computer via a communication cable such as an HDMI (registered trademark) cable or a USB cable. The information processing device 2 is an example of an external device connected to the touch panel display device 1, and the touch panel display device 1 may be installed on an external device such as a tablet terminal or a smartphone and connected to the external device.

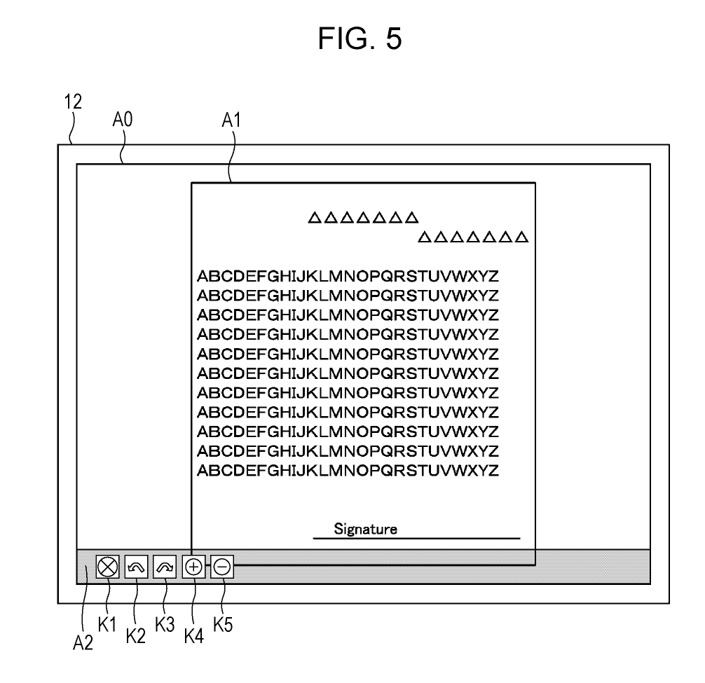

The touch panel display device 1 can display an input image A1 (see FIG. 5) input from the information processing device 2 and can output the result of a touch operation by a user to the information processing device 2. For example, the touch panel display device 1 is a relatively large (for example, 32 inch or larger) display such as a so-called table type touch display embedded in a table or the like, or a multimedia display used in a complex commercial facility or the like.

The touch panel unit 11 includes a touch panel 111 disposed to overlap the front surface of a display unit 12 and a touch controller 112 capable of transmitting and receiving signals to and from the control unit 13 and the information processing device 2. The touch controller 112 is a processor including an MPU, a RAM, a ROM, and the like, or an electronic circuit such as an ASIC. Matters that the control unit 13 also functions as the touch controller 112 and the touch controller 112 is omitted may be considered as another embodiment.

The touch panel 111 can detect a touch operation using a user's finger or a touch pen on the display unit 12. A detection method of the touch operation by the touch panel 111 is, for example, a resistance film method, an electrostatic capacitance method, an infrared blocking method, an infrared camera method, a surface acoustic wave method, an electromagnetic induction method, or the like. The detection method of the touch operation by the touch panel 111 may be an optical input method that detects a touch operation using a dedicated light input pen that irradiates or receives light.

In a case where the touch operation on the display unit 12 is detected by the touch panel 111, the touch controller 112 inputs operation information such as position coordinates of the touch operation to the control unit 13. The touch controller 112 inputs the operation information corresponding to the touch operation into the control unit 13 regardless of whether the position of the touch operation is within or out of an operation restriction range capable of being set in advance. Furthermore, in a case where an OSD image is displayed on the display unit 12, when a touch operation is performed on the OSD image, the touch controller 112 inputs operation information corresponding to the touch operation to the control unit 13, but does not output the operation information to the information processing device 2.

The touch controller 112 can output operation information to the information processing device 2 via the communication cable. More specifically, the touch controller 112 outputs the operation information to the information processing device 2 in a case where the position of the touch operation is within the operation restriction range, and does not output the operation information to the information processing device 2 in a case where the position of the touch operation is out of the operation restriction range.

That is, in the embodiment, the touch controller 112 is an example of a restriction processing unit capable of switching whether to perform output of operation information corresponding to the position of the touch operation to the information processing device 2 according to whether or not the position of the touch operation detected by the touch panel 111 is within the operation restriction range. In a case where the control unit 13 also serves as the function of the touch controller 112, the control unit 13 functions as an example of the restriction processing unit.

In the present embodiment, a case where the operation restriction range is an operation valid range in which the operation information corresponding to the touch operation is output to the information processing device 2 will be described as an example. For example, the operation restriction range is used when the touch operation is restricted so that a signature or memo can be described only in a place which is set in advance. On the other hand, matters that the operation restriction range is an operation invalid range in which the operation information corresponding to the touch operation is not output to the information processing device 2 may be considered. The operation valid range and the operation invalid range may be selectively set as the operation restriction range.

The display unit 12 includes a display panel such as a liquid crystal panel or an organic EL panel, and a driver circuit for driving the display panel to display an image. The display content to be displayed by the display unit 12 is controlled by the control unit 13. The display unit 12 may incorporate a speaker capable of reproducing various kinds of audio signals.

The control unit 13 has control devices such as an MPU, a ROM, and a RAM. The MPU is a processor that executes various kinds of arithmetic processing. The ROM is a nonvolatile storing unit in which information such as a touch panel control program for causing the MPU to execute various kinds of processing is stored in advance. The control unit 13 includes a nonvolatile storing unit 130 such as an EEPROM (registered trademark) for which various kinds of information can be read and write by the MPU and is used for storing various kinds of setting information and the like. The RAM is a volatile storing unit for which various kinds of information can be read and written by the MPU, and is used as a temporary storage memory (work area) for various kinds of processing executed by the MPU.

Meanwhile, in a configuration in which a setting screen is displayed when the operation restriction range is set for restricting validity of an operation on the touch panel 111, there is a problem that it is unable to set the operation restriction range while a positional relationship with the input image A1 displayed on the display unit 12 is actually confirmed. For that reason, in a case where the input image A1 corresponding to document data such as a contract or meeting document is displayed on the display unit 12, it is difficult for the user to randomly set a specific area in the document data as an operation restriction range. Contrary to this, in the touch panel display device 1 according to the embodiment, as will be described below, a desired operation restriction range can be easily set while the positional relationship with the input image A1 displayed on the display unit 12 is ascertained.

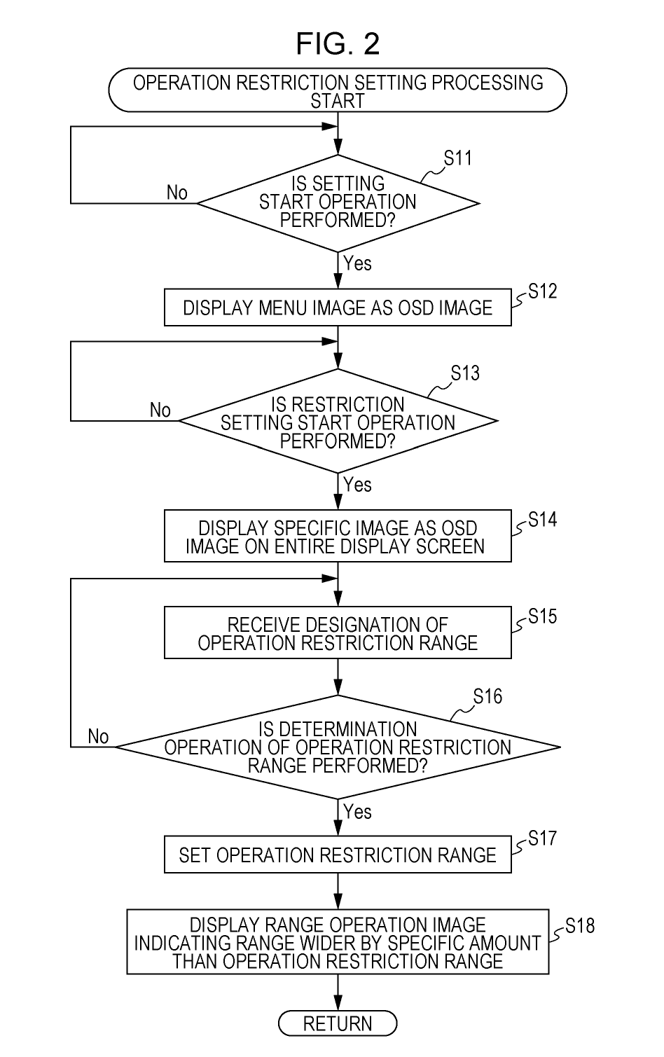

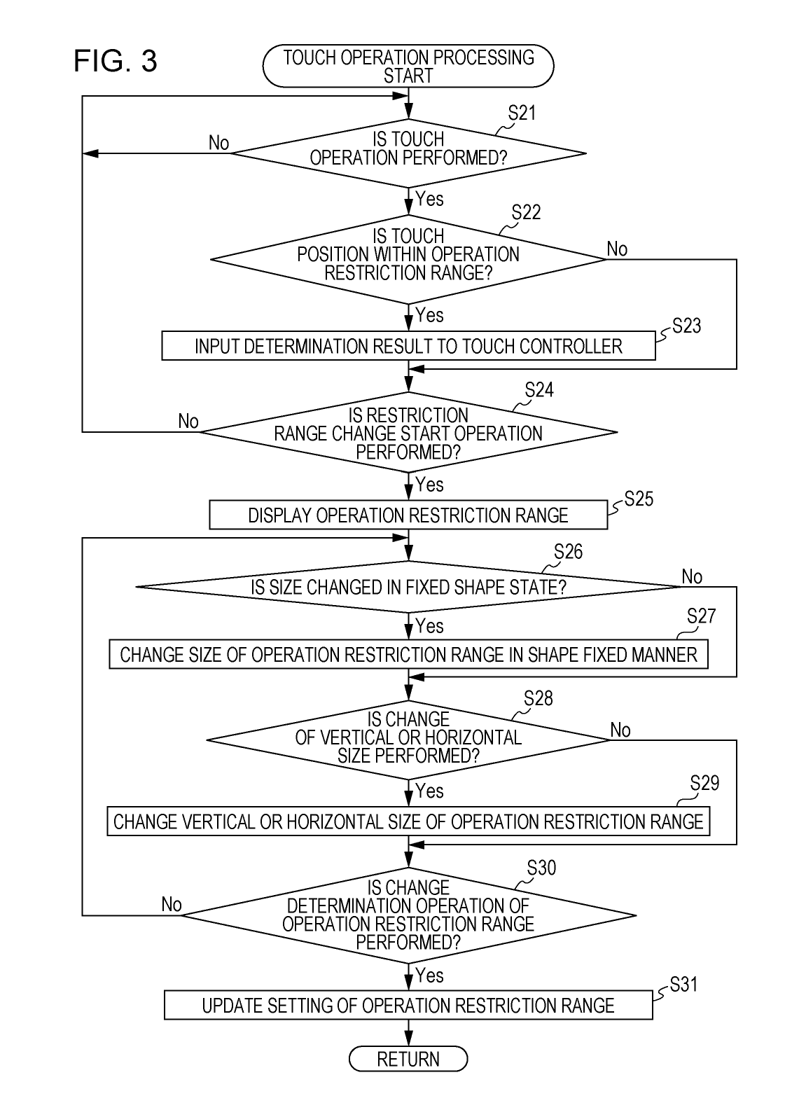

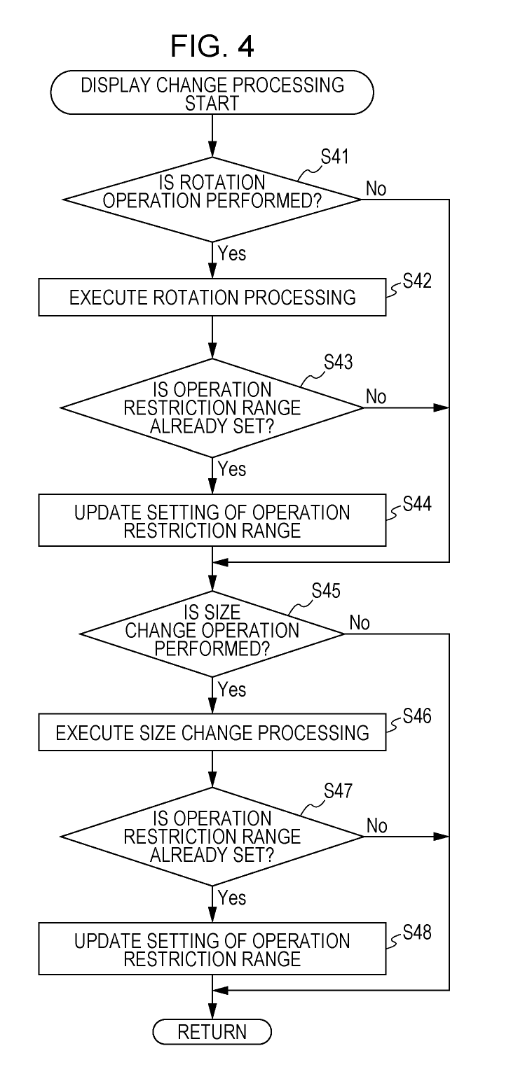

Specifically, the control unit 13 includes a display processing unit 131, a setting processing unit 132, a restriction determination processing unit 133, a signal processing unit 134, and the like. According to the touch panel control program, the control unit 13 functions as various processing units by causing the MPU to execute various kinds of processing such as an operation restriction setting processing (see FIG. 2), a touch operation processing (see FIG. 3), and a display change processing (see FIG. 4). A part or the whole of the display processing unit 131, the setting processing unit 132, the restriction determination processing unit 133, and the signal processing unit 134 may be configured by an electronic circuit. The disclosure can also be regarded as a disclosure of a touch panel control method in which the control unit 13 executes various processing procedures (steps) according to the touch panel control program.

As illustrated in FIG. 5, the display processing unit 131 executes processing for displaying the input image A1 input from the information processing device 2 on a display screen A0 of the display unit 12. For example, the input image A1 is an image corresponding to document data such as a contract or a meeting material. The input image A1 is not limited to a still image, and may be content data, for example, a moving image, a still image with sound or a moving image with sound.

More specifically, as illustrated in FIG. 5, the display processing unit 131 determines the display size of the input image A1 according to a vertical and horizontal size of the display screen A0 and a vertical and horizontal size of the entire input image A1 so that the entire input image A1 is displayed on the display screen A0 at a time. For example, in a case where a ratio of the size in the vertical direction to the size in the horizontal direction of the input image A1 is larger than a ratio of the size in the vertical direction to the size in the horizontal direction of the display screen A0, the control unit 13 causes the input image A1 to be displayed with magnification at which the entire of the input image A1 in the vertical direction is contained in the display screen A0. On the other hand, in a case where a ratio of the size in the horizontal direction to the size in the vertical direction of the input image A1 is larger than a ratio of the size in the horizontal direction to the size in the vertical direction of the display screen A0, the display processing unit 131 causes the input image A1 to be displayed with the magnification at which the entire of the input image A1 in the horizontal direction is contained in the display screen A0. The display processing unit 131 causes the input image A1 to be displayed on the display screen A0 in a state where the center of the input image A1 and the center of the display screen A0 are coincident with each other.

The display processing unit 131 also has an on screen display (OSD) function for displaying other information to be superimposed on the input image A1 which is input from the information processing device 2 and displayed on the display unit 12. Hereinafter, an image displayed by the OSD function may be referred to as an OSD image. Specifically, the display processing unit 131 combines the input image A1 and the OSD image to generate combined image data, and displays the combined image data on the display unit 12. In a case where the OSD image is overlaid and displayed on the input image A1 by the OSD function, the input image A1 displayed on the background of the OSD image is also visible.

For example, as illustrated in FIG. 5, the OSD function is used when a menu image A2 including operation keys K1 to K5 for performing various settings relating to the touch panel display device 1 is displayed as an OSD image. In a case where the OSD image is displayed on the display unit 12, the fact is notified from the display processing unit 131 to the touch controller 112. Then, in a case where a touch operation is performed on the menu image A2 displayed as the OSD image, the touch controller 112 inputs operation information corresponding to the touch operation to the control unit 13, but the operation information is not output to the information processing device 2. Information such as the size or position of the menu image A2 is input from the control unit 13 to the touch controller 112 at the time of the notification, or registered in the touch controller 112 in advance.

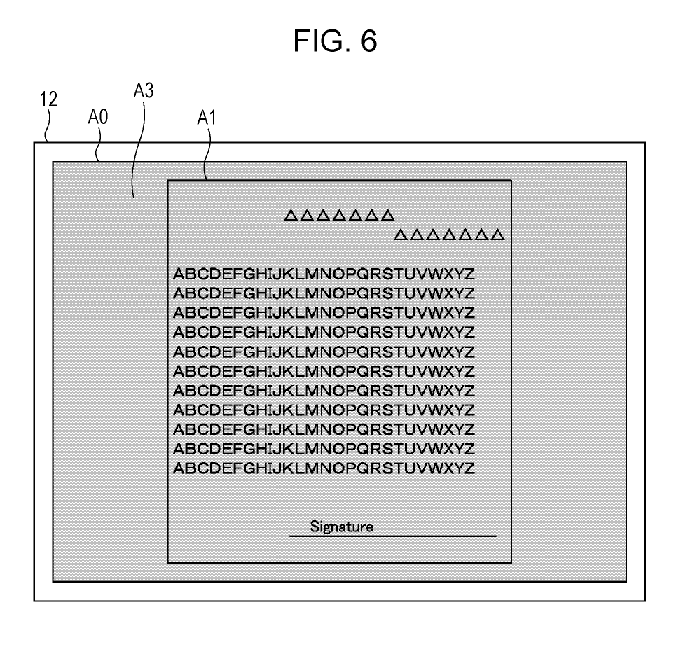

In the touch panel display device 1, when the operation restriction range of the touch operation is set, the display processing unit 131 can display a specific image A3 (see FIG. 6), which is set in advance, as an OSD image, on the entire display screen A0 of the display unit 12 to be superimposed on the input image A1 being displayed on the display unit 12. The specific image A3 is a hatched portion covering the entire display screen A0 in FIG. 6. The specific image A3 is an image having a size corresponding to the entire display screen A0 of the display unit 12 and is a colored image subjected to color arrangement such as gray or blue having low density or translucency. The specific image A3 is not limited to thereto as long as it is an image that allows the user to recognize that the OSD image is displayed on the entire display screen A0. When the input image is displayed on the display unit 12 after the operation restriction range is set, the display processing unit 131 can also display a range operation image A5 indicating a range wider than the operation restriction range by a specific amount on the display unit 12 as an OSD image. The specific image A3 displayed as the OSD image may be displayed on a part of the display screen A0.

The setting processing unit 132 can set the operation restriction range according to a user's operation. In particular, the setting processing unit 132 can set the operation restriction range according to a touch operation on the specific image A3 displayed as an OSD image to be superimposed on the input image A1 being displayed on the display unit 12. Then, the setting processing unit 132 causes the storing unit 130 of the control unit 13 to store, as operation restriction range information, coordinate information and the like that can specify the operation restriction range. For example, in a case where the OSD image is displayed on a part of the display screen A0, matters that the setting processing unit 132 sets the operation restriction range by a user's operation for moving, enlarging, reducing, and the like the OSD image may be considered.

In a case where a touch operation is performed on the display unit 12, the restriction determination processing unit 133 determines, based on the operation information input from the touch controller 112 and the operation restriction range information, whether or not the position of the touch operation is within the operation restriction range. Then, the restriction determination processing unit 133 inputs a determination result as to whether or not the touch operation is within the operation restriction range to the touch controller 112. With this configuration, based on the determination result, it is possible for the touch controller 112 to output the operation information to the information processing device 2 in a case where the position of the touch operation is within the operation restriction range, and it is possible for the touch controller 112 not to output operation information to the information processing device 2 in a case where the position is out of the operation restriction range. Matters that the operation restriction range information set by the restriction setting processing unit 132 is input to the touch controller 112 and the touch controller 112 has a determination function similar to that of the restriction determination processing unit 133 may be considered as another embodiment.

The signal processing unit 134 executes processing for transmitting and receiving signals such as image data to and from an external device such as the information processing device 2. For example, the signal processing unit 134 executes processing of converting image data input from the information processing device 2 into image data in a format that can be displayed on the touch panel display device 1.

In the embodiment, although a case where the operation information is output from the touch controller 112 of the touch panel unit 11 to the information processing device 2 will be described as an example, matters that the signal processing unit 134 of the control unit 13 outputs the operation information input from the touch controller 112 to the information processing device 2 may be considered as another embodiment. Specifically, the signal processing unit 134 switches whether to perform output of operation information corresponding to the touch operation to the information processing device 2 according to whether or not the position of the touch operation is within the operation restriction range, based on the determination result of the restriction determination processing unit 133. In this case, the signal processing unit 134 is an example of the restriction processing unit.

### Operation Restriction Setting Processing

Here, an example of a procedure of operation restriction setting processing executed by the control unit 13 will be described with reference to FIG. 2.

### Step S11

In step S11, the control unit 13 determines whether or not a setting start operation which is set in advance is performed. For example, in a case where the lower end portion or the upper end portion of the display screen A0 of the display unit 12 is touched, the control unit 13 determines that the setting start operation is performed. In a case where a long-press touch operation of the display unit 12 or an operation to slide inward from the outside of the display screen A0 of the display unit 12 is detected, the control unit 13 may determine that the setting start operation is performed. Here, when it is determined that the setting start operation is performed (Yes in S11), the processing proceeds to step S12, and the processing waits in step S11 until it is determined that the setting start operation is performed (No in S11).

### Step S12

In step S12, the display processing unit 131 of the control unit 13 causes the menu image A2 (see FIG. 5) to be displayed as the OSD image on the display unit 12 by the OSD function, and notifies the touch controller 112 of the start of OSD display of the menu image A2. Thereafter, the display processing unit 131 does not display the menu image A2 in a case where the display end operation of the menu image A2 is performed or after a predetermined time elapses. The menu image A2 may be displayed in a state where the input image A1 is not displayed.

As illustrated in FIG. 5, in the menu image A2, touch keys K1 to K5 for receiving various operations are displayed at position coordinates which are set in advance. FIG. 5 illustrates a case where the menu image A2 is displayed at the lower end portion of the display unit 12 according to the touch operation at the lower end portion of the display unit 12. On the other hand, the menu image A2 may be displayed on the upper end portion of the display unit 12 according to the touch operation at the upper end portion of the display unit 12. In this case, the menu image A2 displayed according to the touch operation at the upper end portion of the display unit 12 is an image obtained by rotating the menu image A2 in FIG. 5 by 180 degrees. With this configuration, for example, in a case where the touch panel display device 1 is a table type touch display and different users in face-to-face format with the display unit 12 interposed therebetween are viewing the display unit 12, the user positioned on the opposite side can easily ascertain the contents of the menu image A2.

The touch key K1 is an operation key for receiving a restriction setting start operation for starting setting of the operation restriction range in the display unit 12. The touch key K2 and the touch key K3 are operation keys for receiving a rotation operation for changing a direction of display of the input image on the display unit 12 by a predetermined amount at a time. Specifically, the touch key K2 is an operation key for receiving a counterclockwise rotation operation and a touch key K3 is an operation key for receiving a clockwise rotation operation. The touch key K4 and the touch key K5 are operation keys for receiving a size change operation for changing a display size of the input image on the display unit 12 by a predetermined amount at a time. Specifically, the touch key K4 is an operation key for receiving an enlarging operation and the touch key K5 is an operation key for receiving a shrinking operation. Matters that the operation buttons for receiving operations similar to the touch keys K1 to K5 are provided as hard keys on the front surface, the side surface, the back surface, or the like of the touch panel display device 1 may also be considered as another embodiment.

When a touch operation on the touch keys K1 to K5 is detected by the touch panel 111, operation information corresponding to the touch operation is input from the touch controller 112 to the control unit 13. With this configuration, the control unit 13 can determine that each of the touch keys K1 to K5 is operated based on the operation information and the position coordinates which are set in advance corresponding to each of the touch keys K1 to K5. On the other hand, since the start of the OSD display of the menu image A2 is notified to the touch controller 112, the operation information corresponding to the touch operation on the menu image A2 is input from the touch controller 112 only to the control unit 13 and is not output to the information processing device 2.

### Step S13

In step S13, the control unit 13 determines whether or not the restriction setting start operation which is set in advance is performed. Specifically, in a case where the touch key K1 is operated, the control unit 13 determines that the restriction setting start operation is performed. Here, when it is determined that the restriction setting start operation is performed (Yes in S13), the processing proceeds to step S14, and when it is determined that the restriction setting start operation is not performed (No in S13), the processing waits in step S13. When the menu image A2 is not displayed, the processing returns to step S11. In a state in which the processing waits in step S13, although the control unit 13 executes processing in accordance with an operation of another touch key such as the touch keys K2 to K5, the description will be omitted here.

### Step S14

In step S14, the display processing unit 131 of the control unit 13 displays the specific image A3, which is set in advance, on the entire display screen A0 of the display unit 12 to be superimposed on the input image A1 by the OSD function, and notifies the touch controller 112 of the OSD display start of the specific image A3. The specific image A3 may be displayed in a state where the input image A1 is not displayed. With this configuration, the touch controller 112 inputs operation information corresponding to a touch operation on the touch panel 111 to the control unit 13 until the specific image A3 is removed, but does not output the operation information to the information processing device 2. Information such as the size or position of the specific image A3 is input to the touch controller 112 from the control unit 13 at the time of the notification, or registered in the touch controller 112 in advance.

Here, FIG. 6 is a diagram illustrating an example of a display state of the specific image A3. As illustrated in FIG. 6, on the display screen A0 of the display unit 12, the specific image A3 is displayed on the entire display screen A0 in a state of being superimposed on the front of the input image A1. In this case, the input image A1 is displayed in a state that is visually recognizable to the background of the specific image A3.

### Step S15

In step S15, the setting processing unit 132 of the control unit 13 executes processing for receiving a designation operation of the operation restriction range. For example, in a case where a specific drag-and-drop touch operation for drawing an arbitrary rectangular area is performed on the display unit 12, the setting processing unit 132 receives the rectangular area as the designation operation of the operation restriction range. Specifically, the specific touch operation is an operation of touching an arbitrary position, thereafter moving the touch position while the touch operation is continued, and ending the touch operation at an arbitrary position.

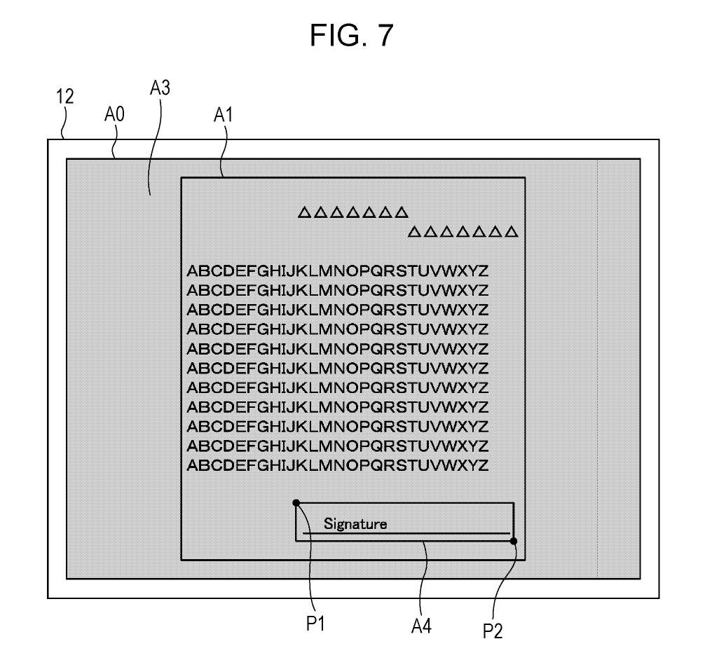

Here, FIG. 7 is a diagram illustrating an example of the designation operation of the operation restriction range. As illustrated in FIG. 7, the setting processing unit 132 receives the designation operation of the operation restriction range in a state where the specific image A3 is displayed as the OSD image on the entire display screen A0 of the display unit 12. That is, regarding the designation operation of the operation restriction range, the operation information is input from the touch controller 112 only to the control unit 13, and is not output to the information processing device 2.

For example, as illustrated in FIG. 7, after the touch operation of an arbitrary first point P1 is performed, in a case where the touch operation is ended after the touch position is slid to an arbitrary second point P2, a rectangular area formed with the first point P1 and the second point P2 as corners on a diagonal line is accepted as an operation restriction range. In the embodiment, the end of the touch operation means that a finger or a touch pen or the like touching the touch panel 111 is separated from the touch panel 111. Here, in a case where the operation of moving the touch position is performed in a state where the touch operation is continued after the touch operation of the first point P1 is performed, the setting processing unit 132 causes the display unit 12 to display the restriction range image A4 indicating the operation restriction range. The restriction range image A4 is a rectangular line image on which color arrangement such as yellow is applied, for example. The restriction range image A4 is not limited to a line image as long as it has visibility as an image illustrating an area, and may be, for example, a colored transparent image or the like.

Besides, in a case where the arbitrary first point P1 and second point P2 are sequentially touched, the setting processing unit 132 may accept a rectangular area, which is formed with the first point P1 and the second point P2 as corners on a diagonal line, as the operation restriction range. In a case where a touch operation to draw an area of an arbitrary shape such as a circle, a rectangle, a polygon, or the like is performed, the setting processing unit 132 may accept the drawn area as the operation restriction range.

Furthermore, in a case where an arbitrary shaped area is drawn, when the arbitrary shape approximates a reference shape, which is set in advance, such as a circle, rectangle, polygon, or the like, which is set in advance, matters that the setting processing unit 132 corrects the arbitrary shaped area to the area of the reference shape may be considered. Thus, even in a case where the user draws a non-smooth circle, rectangle, or polygon, for example, the setting processing unit 132 can accept a smooth circle, rectangle, or polygon area registered in advance as the operation restriction range. The setting processing unit 132 may display the restriction range image A4 indicating an outline of the area after the area of the arbitrary shape is corrected, without displaying a locus of the area when the arbitrary shape area is being drawn.

### Step S16

In step S16, the control unit 13 determines whether or not the determination operation of operation restriction range is performed. Specifically, in a case where the operation restriction range is designated, the control unit 13 displays an operation key for selecting whether or not to determine the operation restriction range, and determines whether to perform the determination operation of operation restriction range according to the selection of the operation key. As described above, after the touch operation at the first point P1 is performed, in a case where the operation restriction range is designated by the operation of moving the touch position in a state where the touch operation is continued, the end of the touch operation may be determined as the determination operation of operation restriction range. Here, when it is determined that the determination operation of operation restriction range is performed (Yes in S16), the processing proceeds to step S17, and the processing returns to step S15 and the designation operation of the operation restriction range is received until the determination operation of operation restriction range is performed (No in S16).

### Step S17

In step S17, the setting processing unit 132 of the control unit 13 sets the range designated in step S15 as the operation restriction range, and does not display the specific image A3 displayed as the OSD image. Specifically, the setting processing unit 132 causes the storing unit 130 to store operation restriction range information such as position coordinates with which the range designated in step S15 can be specified. Although the description is omitted here, in a case where a cancel operation which is set in advance is performed after the operation restriction range is set in step S17, the setting processing unit 132 can cancel the setting of the operation restriction range by erasing the operation restriction range information from the storing unit 130.

### Step S18

In step S18, the display processing unit 131 of the control unit 13 causes the display unit 12 to display, as the OSD image, a range operation image A5 indicating a range wider by a specific amount, which is set in advance, than the operation restriction range and notifies the touch controller 112 of the start of OSD display of the range operation image A5. The range operation image A5 is not limited to a line image as long as it has visibility as an image illustrating an area, and may be, for example, a colored transparent image or the like. The range operation image A5 is displayed as an OSD image on the display unit 12 until the setting of the operation restriction range is canceled after the operation restriction range is set. The display processing unit 131 also stores position information of the range operation image A5 in the storing unit 130. The specific amount is a value which is set in advance for the purpose of securing a distance which is in the vicinity of the operation restriction range and within which the operation restriction range is not erroneously operated. The range operation image A5 has a similarity relationship with the shape (restriction range image A4) of the operation restriction range. In addition, as the range operation image A5 is displayed, the display of the restriction range image A4 is removed.

Information such as the size or position of the menu image A2 is input from the control unit 13 to the touch controller 112 at the time of the notification, or is registered in the touch controller 112 in advance. With this configuration, in a case where the touch operation is performed on the range operation image A5, the touch controller 112 inputs operation information corresponding to the touch operation to the control unit 13, but does not output the operation information to the information processing device 2. Accordingly, as will be described later, the user can change the operation restriction range by the touch operation of the range operation image A5, and unintended operation information within the operation restriction range is not output to the information processing device 2.

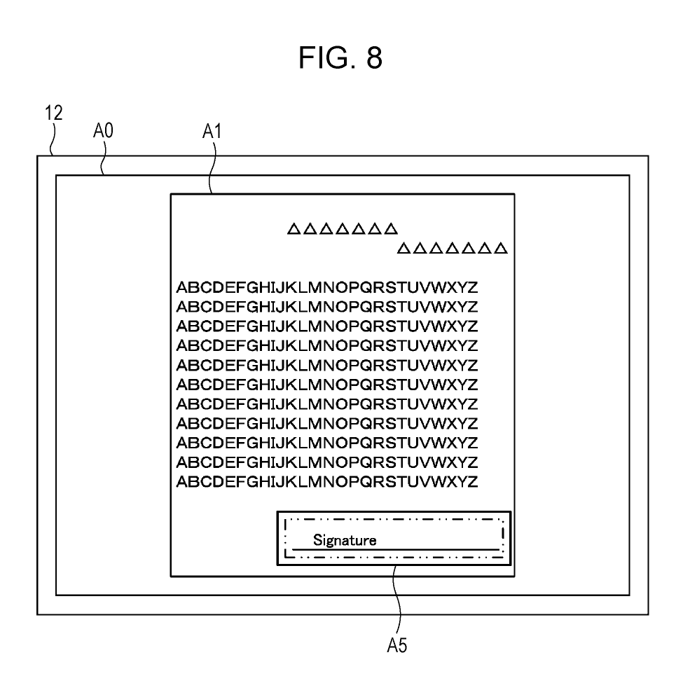

Here, FIG. 8 is a diagram illustrating a display example of the range operation image A5. The two-dot chain line inside the range operation image A5 illustrated in FIG. 8 indicates the operation restriction range. In the example illustrated in FIG. 8, on the display screen A0 of the display unit 12, the range operation image A5 indicating a range wider by the specific amount than the operation restriction range is displayed. In the example illustrated in FIG. 8, although the restriction range image A4 is not displayed on the display screen A0 of the display unit 12, the restriction range image A4 may be displayed on the display screen A0 together with the range operation image A5. Matters that the restriction range image A4 is displayed instead of the range operation image A5 may be considered as another embodiment.

In a case where the operation restriction range is not an operation valid range but an operation invalid range, matters that the range operation image A5 is a range operation image A5 indicating a range narrower than the operation restriction range by the specific amount, which is set in advance, may be considered. With this configuration, it is possible to change the operation restriction range by the touch operation of the range operation image A5, and unintended operation information out of the operation restriction range is not output to the information processing device 2. Furthermore, in the configuration in which the operation valid range and the operation invalid range can be selected as the operation restriction range, matters that in a case where the operation restriction range is an operation valid range, a range wider by the specific amount is displayed than the operation restriction range, and in a case where the operation restriction range is an operation invalid range, a range narrower by the specific amount than the operation restriction range is displayed may be considered.

As described above, in the touch panel display device 1, when the operation restriction range is set, the operation restriction range can be set according to the touch operation on the specific image A3 in a state where the specific image A3 is superimposed and displayed as the OSD image on the input image A1. Accordingly, the user can easily set a desired operation restriction range while ascertaining the positional relationship with the input image A1.

### Touch Operation Processing

Next, an example of a procedure of touch operation processing executed by the control unit 13 will be described with reference to FIG. 3.

### Step S21

In step S21, the control unit 13 determines whether or not a touch operation is detected by the touch panel 111. As described above, in a case where a touch operation is performed, the touch controller 112 inputs operation information which corresponds to the touch operation to the control unit 13, regardless of the setting of the operation restriction range. With this configuration, in a case where the operation information is received from the touch controller 112, the control unit 13 determines that the touch operation is detected. In the touch panel display device 1, the operation information is not output from the touch controller 112 to the information processing device 2 at this point. Here, when it is determined that the touch operation is detected (Yes in S21), the processing proceeds to step S22, and the processing waits in step S21 until the touch operation is detected (No in S21).

### Step S22

In step S22, the restriction determination processing unit 133 of the control unit 13 determines whether or not the touch position of the touch operation corresponding to the operation information is within the operation restriction range, based on the operation information and the information of the operation restriction range. Here, when it is determined that the touch position of the touch operation is within the operation restriction range (Yes in S22), the processing proceeds to step S23, and when it is determined that the touch position of the touch operation is out of the operation restriction range (No in S22), the processing proceeds to step S24.

### Step S23

In step S23, the restriction determination processing unit 133 of the control unit 13 inputs the determination result in step S22 to the touch controller 112. With this configuration, based on the determination result, the touch controller 112 outputs the operation information to the information processing device 2 in a case where the touch position of the touch operation is within the operation restriction range, and does not output the operation information to the information processing device 2 in a case where the touch position of the touch operation is out of the operation restriction range. That is, in the relationship between the touch panel display device 1 and the information processing device 2, the touch operation within the operation restriction range is valid, but the touch operation outside the operation restriction range is invalid.

### Step S24

In step S24, the control unit 13 determines whether or not an operation range change start operation for starting change of the operation restriction range is performed. Specifically, in a case where the touch operation is performed on the range operation image A5 based on the operation information and the position information of the range operation image A5 stored in the storing unit 130, the control unit 13 determines that the operation range change start operation is performed. Even in a case where it is determined that the operation range change start operation is performed, since the range operation image A5 is displayed outside the operation restriction range, the operation result of the range operation image A5 is not output to the information processing device 2. Here, when it is determined that the operation range change start operation is performed (Yes in S24), the processing proceeds to step S25, and when the operation range change start operation is not performed (No in S24), the processing returns to step S21.

### Step S25

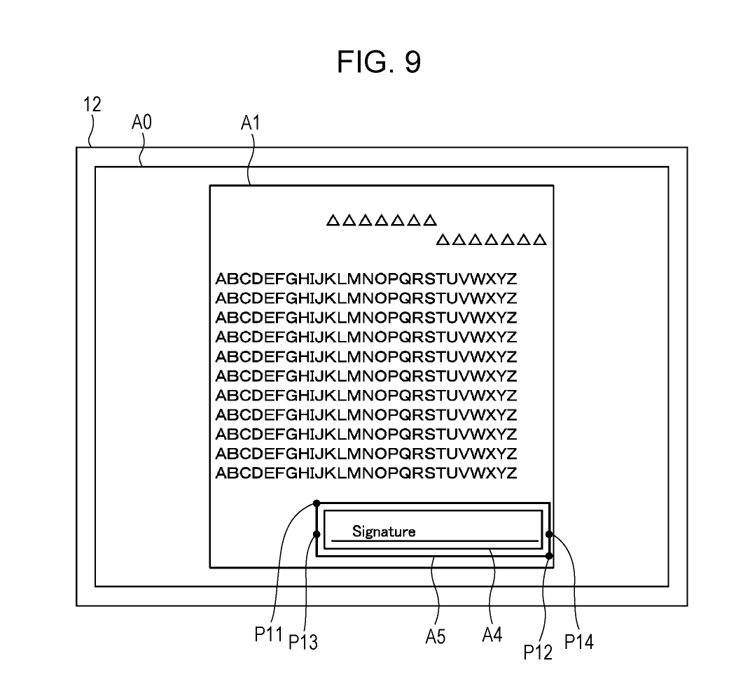

In step S25, the display processing unit 131 of the control unit 13 displays the restriction range image A4 on the display screen A0 of the display unit 12. Here, FIG. 9 is a diagram illustrating a display example when the range operation image A5 is operated. As illustrated in FIG. 9, the display processing unit 131 of the control unit 13 displays the restriction range image A4 and the range operation image A5 on the display screen A0. After the range operation image A5 is operated, the control unit 13 may not cause the range operation image A5 to be displayed and may cause only the restriction range image A4 to be displayed on the display screen A0. Matters that the restriction range image A4 is not displayed may be considered as another embodiment.

### Step S26

In step S26, the control unit 13 determines whether or not a first size change operation for starting change of the size of the entire restriction range image A4 is performed while fixing the shape of the restriction range image A4. Specifically, as illustrated in FIG. 9, in a case where the range operation image A5 is a rectangle, when the touch operation is performed on an arbitrary corner P11 of the range operation image A5, the control unit 13 determines that the first size change operation is performed. Matters that in a case where the range operation image A5 is circular, when a touch operation is being performed on the range operation image A5, the control unit 13 determines that the first size change operation is performed may be considered. Here, when it is determined that the first size change operation is performed (Yes in S26), the processing proceeds to step S27, and when it is determined that the first size change operation is not performed (No in S26), the processing proceeds to step S28.

### Step S27

In step S27, the setting processing unit 132 of the control unit 13 changes the size of the restriction range image A4 in a shape fixed manner according to a movement operation of the touch position of the touch operation being performed on the range operation image A5. That is, the restriction range images A4 before and after the size change are in a similarity relationship. For example, in a case where the restriction range image A4 is the rectangle as illustrated in FIG. 9, the setting processing unit 132 fixes the corner P12 as a reference on the opposite side of the corner P11 of the first touch position on the diagonal and enlarges or reduces the whole of the restriction range image A4 according to the movement operation of the touch position, in a state of maintaining the aspect ratio of the rectangle.

### Step S28

In step S28, the control unit 13 determines whether or not a second size change operation for starting the change of one of the vertical and horizontal size of the restriction range image A4 is performed. Specifically, as illustrated in FIG. 9, in a case where the range operation image A5 is the rectangle, when a touch operation is performed on an arbitrary straight line portion P13 of the range operation image A5, the control unit 13 determines that the second size change operation is performed. Here, when it is determined that the second size change operation is performed (Yes in S28), the processing proceeds to step S29, and when it is determined that the second size change operation is not performed (No in S28), the processing proceeds to step S30.

### Step S29

In step S29, the setting processing unit 132 of the control unit 13 changes the size of the restriction range image A4 in one of the vertical and horizontal directions according to the movement operation of the touch position detected by the touch panel 111. That is, the restriction range images A4 before and after the size change are not in a similarity relationship. For example, in a case where the restriction range image A4 is the rectangle as illustrated in FIG. 9, the setting processing unit 132 does not maintain the aspect ratio of the rectangle, fixes a straight line portion P14 facing a straight line portion P13 of the first touch position as a reference, and enlarges or reduces the restriction range image A4 vertically or horizontally.

### Step S30

In step S30, the control unit 13 determines whether or not a change determination operation is performed on the size change operation of the restriction range image A4 performed in step S27 or S29. Specifically, the control unit 13 determines that the change determination operation is performed in a case where the touch operation on the touch panel 111 performed for changing the restriction range image A4 is ended. Here, when it is determined that the change determination operation is performed (Yes in S30), the processing proceeds to step S31, and the processing returns to step S26 until it is determined that the change confirmation operation is performed (No in S30).

### Step S31

In step S31, the control unit 13 updates the setting of the operation restriction range based on the restriction range image A4 when it is determined that the change confirmation operation is performed in step S30. Thus, the restriction determination processing unit 133 determines validity of the touch operation based on the updated operation restriction range for the subsequent touch operation.

As described above, in the touch panel display device 1, when the operation restriction range is set, the range operation image A5 for indicating the operation restriction range is also displayed during display of the normal input image A1. In the touch panel display device 1, the operation restriction range can be changed by operating the range operation image A5. Accordingly, when changing the operation restriction range which is set once, the user can easily change the operation restriction range by omitting the display operation of the menu image A2 and the like. In particular, since the range operation image A5 is displayed as the OSD image, even in a case where the touch operation is performed within the operation restriction range at the time of the change operation for reducing the operation restriction range, the operation information corresponding to the touch operation is obstructed from being output to the information processing device 2.

### Display Change Control Processing

Subsequently, an example of a procedure of display change control processing executed by the control unit 13 will be described with reference to FIG. 4.

### Step S41

In step S41, the display processing unit 131 of the control unit 13 determines whether or not a rotation operation for rotating a direction of display of the input image A1 on the display unit 12 is performed. Specifically, in a case where the operation key K2 or the operation key K3 is operated after the menu image A2 is displayed, the display processing unit 131 determines that the rotation operation is performed. Here, when it is determined that the rotation operation is performed (Yes in S41), the processing proceeds to step S42, and when it is determined that the rotation operation is not performed (No in S41) the processing proceeds to S45.

### Step S42

In step S42, the display processing unit 131 of the control unit 13 executes rotation processing for rotating the direction of display of the input image A1 on the display unit 12 according to the content of the rotation operation. For example, every time the operation key K2 is operated, the display processing unit 131 rotates the direction of display of the input image A1 by 90 degrees counterclockwise. Every time the operation key K3 is operated, the display processing unit 131 rotates the direction of display of the input image A1 by 90 degrees clockwise. The rotation processing of the input image A1 is performed with the center of the display screen A0 of the display unit 12 as the rotation axis. The center of rotation of the input image A1 may also be randomly designated by the user's operation.

In a case where the input image A1 is rotated by the rotation processing, the display processing unit 131 notifies the touch controller 112 of the content of the rotation processing at a timing, which is set in advance, such as the timing of notifying the determination result. With this configuration, in a case where the input image A1 is rotated by the rotation processing, the touch controller 112 changes the content of the operation information according to the content of the rotation processing and outputs the content to the information processing device 2. For example, in a case where the input image A1 is rotated by 180 degrees, the touch controller 112 converts the position coordinates indicated by the operation information into position coordinates obtained by rotating the position coordinates by 180 degrees and outputs the position coordinates to the information processing device 2.

### Step S43

In step S43, the setting processing unit 132 of the control unit 13 determines whether or not the operation restriction range is already set in the operation restriction setting processing. For example, in a case where operation restriction range information indicating the operation restriction range is stored in the storing unit 130, the setting processing unit 132 determines that the operation restriction range is already set. Here, when it is determined that the operation restriction range is set (Yes in S43), the processing proceeds to step S44, and when it is determined that the operation restriction range is not set (No in S43), the processing proceeds to step S45.

### Step S44

In step S44, the setting processing unit 132 of the control unit 13 updates the setting of the operation restriction range following the rotation of the input image A1 executed in step S42. In particular, the setting processing unit 132 executes processing for changing the position of the operation restriction range and the position of the range operation image A5 following the rotation of the input image A1. Specifically, the setting processing unit 132 rotates the operation restriction range by the same angle as the rotation angle of the input image A1 around the same position as the rotation center of the input image A1. For example, in a case where the operation restriction range is a rectangle, the setting processing unit 132 changes the position coordinates of the four corner portions in the operation restriction range to the coordinates of a position rotated by the same angle as the rotation angle of the input image A1 around the same position as the rotation center of the input image A1. The control unit 13 changes the position of the range operation image A5 in the same manner as the operation restriction range.

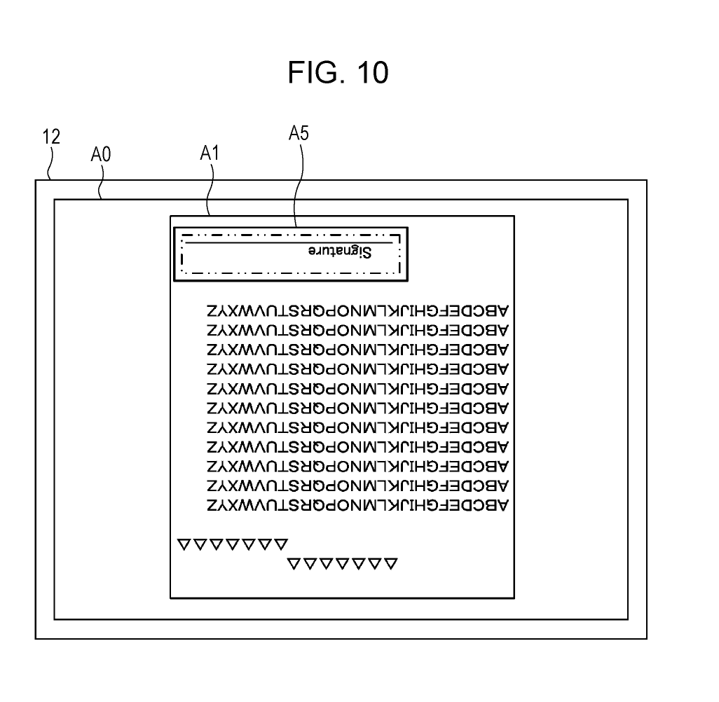

Here, FIG. 10 is a diagram illustrating a display example in a case where the input image A1 is rotated by 180 degrees from the state illustrated in FIG. 5. The two-dot chain line inside the range operation image A5 illustrated in FIG. 10 indicates the operation restriction range. As illustrated in FIG. 10, as the input image A1 is rotated by 180 degrees from the state illustrated in FIG. 5, the operation restriction range and the operation image A5 are also rotated by 180 degrees from the state illustrated in FIG. 5. With this configuration, even after the direction of display of the input image A1 is changed, the positional relationship between the input image A1 and the operation restriction range and the operation image A5 is maintained and the validity of the touch operation on a specific range which is set as the operation restriction range in the input image A1 is secured.

### Step S45

In step S45, the display processing unit 131 of the control unit 13 determines whether or not a size change operation for changing a display size of the input image A1 on the display unit 12 is performed. Specifically, in a case where the operation key K4 or the operation key K5 is operated after the menu image A2 is displayed, the display processing unit 131 determines that the size change operation is performed. Even in a case where the display size of the input image A1 needs to be automatically changed (scaled) due to the rotation of the direction of display of the input image A1 by the rotation processing, the display processing unit 131 determines that the size change operation is performed. When it is determined that the size change operation is performed (Yes in S45), the processing proceeds to step S46, and when it is determined that the size change operation is not performed (No in S45), the processing returns to step S41.

### Step S46

In step S46, the display processing unit 131 executes the size change processing for changing the display size of the input image A1 on the display unit 12 according to the content of the size change operation. Specifically, every time the operation key K4 is operated, the display processing unit 131 enlarges the display size of the input image A1 by 20% with respect to the current display size by using the center of the display screen A0 of the display unit 12 as a reference. Also, every time the operation key K5 is operated, the display processing unit 131 reduces the display size of the input image A1 by 20% with respect to the current display size by using the center of the display screen A0 of the display unit 12 as the reference. In the size change processing, in a case where the display size of the input image A1 after enlargement processing exceeds the display size of the display screen A0, the excess area becomes out of display targets. Further, a position serving as a reference for changing the size of the input image A1 may be randomly designated by the user's operation.

Furthermore, in a case where the aspect ratio of the input image A1 on the display screen A0 changes due to rotation processing by the rotation processing, the display processing unit 131 may automatically enlarge or reduce the display size of the input image A1 according to the aspect ratio of the input image A1 after the change. For example, in a case where the direction of the input image A1 is rotated by 90 degrees in a state where the input image A1 is displayed with a display size matching the size in the vertical direction of the display screen A0, the input image A1 is displayed with the magnification at which the entire input image A1 is contained in the horizontal size of the display screen A0. On the other hand, in a case where the input image A1 is rotated by 90 degrees in a state where the input image A1 is displayed with the display size matching the size in the horizontal direction of the display screen A0, the input image A1 is displayed with the magnification at which the entire input image A1 is contained in the vertical size of the display screen A0.

### Step S47

In step S47, the setting processing unit 132 of the control unit 13 determines whether or not the operation restriction range is already set in the operation restriction setting processing. For example, in a case where setting information of the operation restriction range is stored in the storing unit 130, the setting processing unit 132 determines that the operation restriction range is already set. Here, when it is determined that the operation restriction range is already set (Yes in S47), the processing proceeds to step S48, and when it is determined that the operation restriction range is not set (No in S47), the processing returns to step S41.

### Step S48

In step S48, the setting processing unit 132 updates the setting of the operation restriction range following the change in the display size of the input image A1 executed in step S46. In particular, the setting processing unit 132 executes processing for changing the size of the operation restriction range following the change in the display size of the input image A1. Specifically, the setting processing unit 132 enlarges or reduces the size of the operation restriction range with the same magnification as the display size of the input image A1 around the same position as the center at the time of changing the display size of the input image A1.

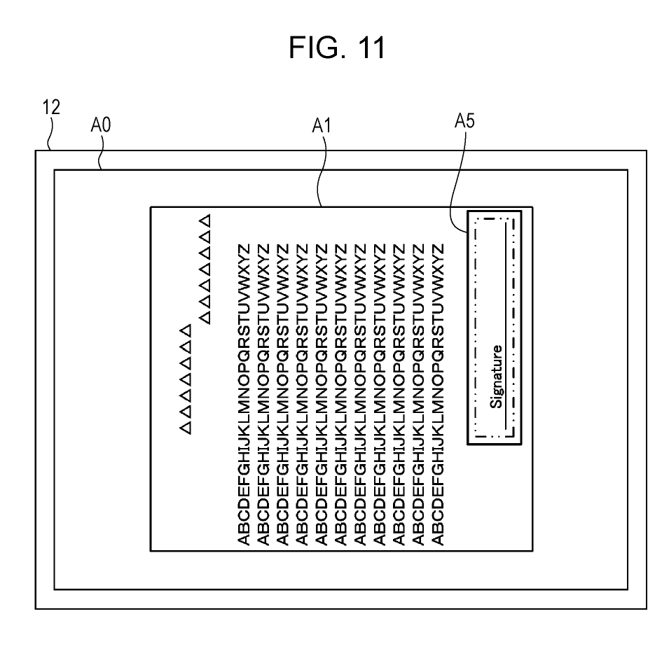

Here, FIG. 11 is a diagram illustrating a display example in the case where the input image A1 is automatically scaled and displayed by the input image A1 being rotated by 90 degrees to the left from the state illustrated in FIG. 5 due to the operation of the touch key K2. The two-dot chain line inside the range operation image A5 illustrated in FIG. 11 indicates the operation restriction range. As illustrated in FIG. 11, as the input image A1 is rotated to the left by 90 degrees from the state illustrated in FIG. 5, the operation restriction range and the operation image A5 are also rotated from the state illustrated in FIG. 5 to the left by 90 degrees. Furthermore, as the display size of the input image A1 is scaled from the state illustrated in FIG. 5, the operation restriction range and the operation image A5 are also scaled from the state illustrated in FIG. 5. With this configuration, even after the direction and size of the display of the input image A1 are changed, the positional relationship between the input image A1 and the operation restriction range and the operation image A5 is maintained, and the validity of the touch operation on the specific range which is set as the operation restriction range in the input image A1 is secured.

As described above, in the touch panel display device 1, in a case where the display size or the direction of display of the input image A1 on the display unit 12 is changed, the setting processing unit 132 automatically changes the operation restriction range following the change. Accordingly, it is possible for the user to omit the trouble of resetting the operation restriction range when changing the display size or direction of display of the input image A1.

As a display change method of the input image A1, matters that the display processing unit 131 reduces and displays the input image A1 at the magnification at which the input image A1 is contained in the operation restriction range in a case where a specific operation such as a double tap operation within the operation restriction range is performed may be considered. However, in this case, since the entire input image A1 is contained in the operation restriction range, the setting processing unit 132 does not change the size of the operation restriction range following reduction display of the input image A1. With this configuration, in a case where the user performs an operation on the input image A1, the user can easily perform the operation while the input image A1 is kept within the operation restriction range in which the touch operation is effectively processed.

Matters that the setting processing unit 132 enlarges the operation restriction range at the magnification at which the input image A1 is contained in the operation restriction range in a case where the specific operation such as the double tap within the operation restriction range is performed may be considered as another embodiment. Also in this case, since the entire input image A1 is contained in the operation restriction range, the setting processing unit 132 does not change the size of the operation restriction range following the reduction display of the input image A1. With this configuration, in a case where the user performs an operation on the input image A1, the user can easily perform the operation while the input image A1 is kept within the operation restriction range in which the touch operation is effectively processed.

In the meantime, a configuration in which the setting processing unit 132 can selectively set, as the operation restriction range, a first operation restriction range in which an operation relating to the display content of the display unit 12 is a restriction target and a second operation restriction range in which the drawing operation on the display unit 12 is a restriction target may be considered as another embodiment. Specifically, the first operation restriction range is used for operations such as enlargement, reduction, rotation, page feed, scroll, and the like of the input image A1 displayed on the display unit 12. For example, in a case where the touch panel 111 is a capacitive type touch panel capable of detecting a multi-point simultaneous operation or the like, in the first operation restriction range, a change operation of a display mode of the input image A1 by a multi-touch operation using two fingers of the user is performed. The second operation restriction range is used for operations such as text input, graphics drawing, or the like using a touch pen. In this case, the display processing unit 131 displays the range operation image A5 corresponding to each of the first operation restriction range and the second operation restriction range on the display unit 12 so as to be distinguishable in a manner that the color arrangement or the line type is different. Then, in this case, it is conceivable that when a change operation of the display size or the direction of display of the input image A1 displayed on the display unit 12 is performed, following the change operation, the setting processing unit 132 changes the second operation restriction range but does not change the first operation restriction range. With this configuration, even if the display size or the direction of display of the input image A1 is changed, since the position is fixed with respect to the first operation restriction range used for the operation relating to the display content of the display unit 12, the user can perform the operation using the first operation restriction range at the same position.

Furthermore, a configuration in which the setting processing unit 132 is capable of changing the operation restriction range following the scroll operation or movement operation of the input image A1 being displayed on the display unit 12 may be considered as another embodiment. Specifically, matters that the display processing unit 131 can perform scroll display or movement display of the input image A1 according to the scroll operation or the movement operation on the display unit 12 may be considered. Then, the setting processing unit 132 stores the restriction target image displayed within the operation restriction range in the storing unit 130 when the operation restriction range is set by the setting processing unit 132. Thereafter, in a case where the scroll operation or the movement operation is performed on the display unit 12 and the scroll display or the movement display of the input image A1 is performed, the setting processing unit 132 sets an area coincident with the restriction target image in the input image A1 being displayed on the display unit 12 by the display processing unit 131 as the operation restriction range. With this configuration, even in a case where the scroll display or movement display is performed on the input image A1, the positional relationship between the input image A1 and the operation restriction range can be maintained and the trouble that the user resets the operation restriction range can be omitted.

The present disclosure contains subject matter related to that disclosed in Japanese Priority Patent Application JP 2017-217072 filed in the Japan Patent Office on Nov. 10, 2017, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A touch panel display device comprising:
a display unit;
a touch panel capable of detecting a position of a touch operation on the display unit;
a display processing unit capable of displaying, as an on screen display (OSD) image, a specific image set in advance by superimposing the specific image on a part or all of a display screen of the display unit in a state where an input image is being displayed on the display unit;
a setting processing unit capable of setting an operation restriction range according to a touch operation on the specific image; and
a restriction processing unit capable of switching whether to perform output of operation information corresponding to the position of the touch operation to an external device according to whether the position of the touch operation detected by the touch panel is within the operation restriction range.

2. The touch panel display device according to claim 1,
wherein the display processing unit causes the specific image to be displayed as the on screen display (OSD) image.

3. The touch panel display device according to claim 1, wherein
the operation restriction range is an operation valid range for which the operation information corresponding to the touch operation is output, and
the restriction processing unit outputs the operation information in a case where the position of the touch operation detected by the touch panel is within the operation valid range and does not output the operation information in a case where the position of the touch operation detected by the touch panel is out of the operation valid range.

4. The touch panel display device according to claim 3, wherein
the display processing unit is capable of displaying a range operation image indicating a range wider by a specific amount than the operation restriction range on the display unit after setting the operation restriction range by the setting processing unit, and
the setting processing unit is capable of changing the operation restriction range according to an operation on the range operation image.

5. The touch panel display device according to claim 1,
wherein the setting processing unit changes the operation restriction range following a change operation of a display size or a direction of display of the input image displayed on the display unit.

6. The touch panel display device according to claim 5, wherein
the setting processing unit is capable of selectively setting a first operation restriction range in which an operation related to a display content of the display unit is a restriction target and a second operation restriction range in which a drawing operation on the display unit is a restriction target, as the operation restriction range, and
the setting processing unit changes the second operation restriction range and does not change the first operation restriction range in the operation restriction range following the change operation of the display size or the direction of display of the input image displayed on the display unit.

7. The touch panel display device according to claim 1,
wherein the setting processing unit changes the operation restriction range following a scroll operation or a movement operation of the input image displayed on the display unit.

8. The touch panel display device according to claim 1, further comprising:
a control unit that includes the setting processing unit, the display processing unit, and a restriction determination processing unit that determines whether the position of the touch operation detected by the touch panel is within the operation restriction range; and
a touch panel unit that includes the touch panel and the restriction processing unit,
wherein the restriction processing unit inputs the operation information corresponding to the touch operation detected by the touch panel to the restriction determination processing unit and switches whether to perform output of the operation information corresponding to the position of the touch operation to the external device according to a determination result input from the restriction determination processing unit.

9. A touch panel control method executed in a touch panel display device including a display unit and a touch panel capable of detecting a position of a touch operation on the display unit, the method comprising:
displaying a specific image on a part or all of a display screen of the display unit in a state where an input image is being displayed on the display unit;
setting an operation restriction range according to a touch operation on the specific image; and
switching whether to perform output of operation information corresponding to the position of the touch operation to an external device according to whether the position of the touch operation detected by the touch panel is within the operation restriction range.

10. A non-transitory recording medium storing a program that causes a computer of a touch panel display device including a display unit and a touch panel capable of detecting a position of a touch operation on the display unit to execute a process, the process comprising:
displaying a specific image on a part or all of a display screen of the display unit in a state where an input image is being displayed on the display unit;
setting an operation restriction range according to a touch operation on the specific image; and
switching whether to perform output of operation information corresponding to the position of the touch operation to an external device according to whether the position of the touch operation detected by the touch panel is within the operation restriction range.
